(19) United States
(12) Patent Application Publication
(10) Pub. No.: US 2004/0112389 A1
(43) Pub. Date: Jun. 17, 2004

(54) Impact and energy absorbing mouth guard

(76) Inventor: Carl J. Abraham, Great Neck, NY (US)

Correspondence Address: Carl J. Abraham, 3 Baker Hill Road, Great Neck, NY, 11023, US

(21) Appl. No.: 10/316,313

(22) Filed: Dec. 11, 2002

(51) Int. Cl. A61C 5/14

(52) U.S. Cl. 128/859

(57) ABSTRACT

An energy absorbing system for mouth guards, utilizing a series of encapsulated springs that are always in a state of suspension. In the preferred mode, the encapsulated springs are conical in nature, and alternate between standard and upside-down orientation, providing the utmost in strength and support while preventing the springs from bottoming out upon impact Importantly, an encapsulating material placed at least around a plurality of conical springs prevents the springs from being continually placed in a stressed situation, thus maintaining their structural integrity. Such encapsulating material may be made of a polymeric or thermoplastic material, which conforms to the conical shape of the springs and their respective apertures, functioning to aid in the dissipation of impact forces. In enhanced modes, the polymeric or thermoplastic material may also be placed within the interior of a conical spring, to provide additional stability and absorption and dissipation of forces. The uniqueness of the encapsulation of the springs is that such a configuration allows for specific designs, lengths, and widths, as well as ease of placement in pre-formed openings in the padding or encapsulating material for the manufacture of the final product. Because the springs work in conjunction with one another, and because the springs work in conjunction with the encapsulating material, the present invention provides a durable, long-lasting system that allows for previously-unattained stability.

### BACKGROUND OF THE INVENTION

1. Field of the Invention

The present invention is an energy absorbing system for mouth guards, utilizing a series of encapsulated springs that are always in a state of suspension In the preferred mode, the encapsulated springs are conical in nature, and alternate between standard and upside-down orientation, providing the utmost in strength and support while preventing the springs from bottoming out upon impact. Importantly, an encapsulating material placed at least around a plurality of conical springs prevents the springs from being continually placed in a stressed situation, thus maintaining their structural integrity. Such encapsulating material may be made of a polymeric or thermoplastic material, which conforms to the conical shape of the springs and their respective apertures, functioning to aid in the dissipation of impact forces. In enhanced modes, the polymeric or thermoplastic material may also be placed within the interior of a conical spring, to provide additional stability and absorption and dissipation of forces. The uniqueness of the encapsulation of the springs is that such a configuration allows for specific designs, lengths, and widths, as well as ease of placement in pre-formed openings in the padding or encapsulating material for the manufacture of the final product. Because the springs work in conjunction with one another, and because the springs work in conjunction with the encapsulating material, the present invention provides a durable, long-lasting system that allows for previously-unattained stability

2. Description of the Prior Art

Numerous innovations for energy absorbing mouthpiece designs have been provided in the prior art that are described as follows. Even though these innovations may be suitable for the specific individual purposes to which they address, they differ from the present invention as hereinafter contrasted. The following is a summary of those prior art patents most relevant to the invention at hand, as well a description outlining the differences between the features of the present invention and those of the prior art.

1. U.S. Pat. No. 5,732,715, invented by Jacobs et al, entitled “Mouthpiece”

The patent to Jacobs, et al. describes a resilient composition including a thermoplastic material and gas pockets dispersed therein, where the pockets being formed by a blowing agent. A mouthpiece including a resilient thermoplastic material having a quantity of gas pockets dispersed therein. A method of making a mouthpiece achieved by first mixing a predetermined quantity of blowing agent with a resilient thermoplastic material. The mixture is then heated to a predetermined temperature forming gas pockets therein from the decomposition of the blowing agent. The mixture is then ejection molded in a mold to form the mouthpiece. A mouthpiece including a U-shaped base having a U-shaped cross-section. The base including a lower, horizontal floor with upwardly extending inner lingual and outer labial walls and having a posterior section proximate the user's molar teeth and an anterior section proximate the user's canine and incisor teeth. The mouthpiece including a continuous ridge integral with the base and having an outer horizontal portion disposed on the exterior surface of the outer labial wall of the anterior section and terminating in opposite inner horizontal portions disposed on the interior surface of the horizontal floor of the posterior section.

2. U.S. Pat. No. 5,339,832, invented by Kittelsen et al , entitled “Thermoplastic Mouthguard With Integral Shock Absorbing Framework”

The patent to Kittelsen describes a composite mouthguard which has a flexible and tough, softenable thermoplastic mouthguard portion with a U-shaped base having upward inner lingual and outer labial walls extending from the base A shock absorbing and attenuating nonsoftening, resilient, low compression, elastomer framework is embedded in the mouthguard portion to absorb, attenuate and dissipate shock forces exerted on the mouthguard during athletic activity.

3. U.S. Pat. No. 5,235,991, invented by Minneman, entitled “Mouth Guard”

The patent to Minneman describes a mouthguard with two main portions, a stiff, thin planar portion and compressible portion. The planar portion is capable of deflecting mouth and cheek tissues. The planar portion extends from two arms, the outer and upper aspect of a solid triangle, to a handle opposite the arms. The compressible portion extends above and below the plane of the planar portion on each arm.

4. U.S. Pat. No. 6,082,363, invented by Washburn, entitled “Triple Layer Mouthguard Having Integral Shock Absorbing Framework”

The patent to Washburn describes a triple layer mouthguard which has a U-shaped base with an elastomeric frame embedded therein. The frame includes a wave-shaped contact surface. The mouthguard base includes inner and outer side walls defining an upper channel which has a liner disposed therein The liner is adapted to form around the teeth when softened The liner engages the teeth of the upper jaw and is made of a material that softens at a temperature lower than the material of the mouthguard base and becomes softer than the material of the base when hardened.

5. U.S. Pat. No. 6,397,848, invented by Kagekata et al., entitled “Mouthguard Composition”

In the patent to Kagekata, a mouthguard composition is disclosed, containing (a) from 40 to 80% by weight of a styrene block copolymer, (b) from 20 to 60% by weight of an alicyclic saturated hydrocarbon resin and/or an ester gum, and (c) from 0.1 to 10% by weight of an organopolysiloxane in which at least one of organic groups directly bound to the silicon atom in one molecule thereof is a phenyl group, a methylstyryl group, or an alkyl group having from 7 to 30 carbon atoms. The mouthguard composition is high in durability and impact absorption and is free from sticking to gypsum model or hands and fingers at the time of preparation and adjustment works.

6. U.S. Pat. No. 5,692,523, invented by Croll et al., entitled “Two Piece Mouthguard”

In the patent to Croll, a two-piece mouthguard is composed of separate pieces of flat cushioning material which contain pre-formed notches, cutouts and holes that permit the separate pieces to be fitted together into the proper shape and configuration of a mouthguard A horseshoe-shaped bite plate member includes a pair of left and right curved slots and a frontal interlocking tab joint which secures the bite plate member to a vertical member which after assembly assumes the approximate shape of the dental arch. The vertical member includes a centrally-located slot which receives the interlocking tab on the bite plate member. A handgrip projects from the front of the bite plate member which includes an aperture that may be used to secure a tether.

7. U.S. Pat. No. 4,765,324, invented by Lake, Jr., entitled “Sports Mouthguard With Shim”

The patent to Lake, Jr. describes a new and improved mouthguard adapted to minimize shock to the teeth and head area The mouthguard is comprised of a member having an approximate U-shape corresponding generally to the shape of the arch of the upper jaw. The member, which is of substantially channel shape in cross section, is fitted over the upper teeth. The member has a bottom wall designed to engage the lower teeth. The construction of the bottom wall is a sandwich or layered configuration comprised of an energy absorbing elastomer enclosed in a tough, durable and less compressible material.

8. U.S. Pat. No. 5,865,619, invented by Cross, III et al., entitled “Triple Composite Performance Enhancing Dental Appliance”

The patent to Cross et al. describes a performance enhancing and force absorbing dental appliance adapted to lie within the mouth of an athlete and consists of an occlusal posterior pad made of triple composite material with a base having a top layer of impressionable material, an intermediate layer of hard material and a somewhat impressionable bottom layer, engageable with the occlusal surfaces to space apart the upper and lower teeth, to absorb shock and clenching stress. An adjustable arch adapted to expand and contract to be molded to the palate is provided connecting the posterior pads together within the mouth and out of the way of the tongue to maintain the position of the occlusal posterior pads within the mouth during use and to prevent loss of the pads such as by swallowing. An optional expandable stiffener may be embedded in the arch. Optional protrusions extend from the bottom layer through the intermediate layer and top layer to engage the central fossae of the molar teeth

9. U.S. Pat. No. 5,718,575, invented by Cross, III, entitled “Adjustable, Customizable Performance Enhancing Dental Appliance”

In the patent to Cross, a performance enhancing and force absorbing dental appliance for the mouth of an athlete is comprised of an occlusal posterior pad for each side of the posterior teeth engageable with the occlusal surfaces to space apart the teeth, to absorb shock and clenching stress. An arch is provided connecting the posterior pads together within the mouth and out of the way of the tongue to maintain the position of the occlusal posterior pads within the mouth during use and to prevent loss of the pads such as by swallowing.

10. U.S. Pat. No. 5,636,379, invented by Williams, entitled “Jaw-Joint Protective Device”

The patent to Williams discloses a jaw joint protective device is provided for protecting teeth, lips, jaw, and other delicate structures of the vital cranial triad (VCT) from injury and/or for supporting the condyle of the temporomamdibular joint (TMJ) in a relatively fixed (stable) position thereby stabilizing the jaw and the VCT during head contact activity and or permit the components of a VCT disorder to be realigned for proper healing. This device is an over-the counter purchased, boil and bite jaw-joint protector providing maxillary and mandibular teeth seats for protection of the mouth and/or healing of the VCT. This invention provides for customized over-the counter availability that adds speech and airway capabilities to the device to facilitate sports participation.

The aforementioned prior art patents illustrate various mouthguard designs, including: mouthpieces with air or gas pockets for absorption and dissipation of forces; two-piece mouthguards with cushioning materials; triple-layer mouthguards; and various other mouthpieces with padding and spacers designed to protect the teeth upon impact of forces.

In contrast to the above, the present invention absorbs and dissipates impact forces, as distinguished from keeping the teeth in place upon impact. To accomplish this, the present invention is an energy absorbing system utilizing a series of encapsulated conical springs that are always in a state of suspension. The springs are placed within conical pre-formed openings in surrounding padding to allow for enhanced absorption and dissipation of impact forces. The conical springs and surrounding polymeric material work as a single system to absorb and dissipate more forces than each individual component can accomplish individually. As such, the present invention can absorb and dissipate up to 50% of the forces applied to the mouth and jaw area upon impact, thereby reducing the incidence of brain trauma.

Importantly, the comical springs alternate between straight up and upside-down configuration, to enhance the degree to which the system can absorb and dissipate forces. Moreover, the polymeric material may be located within the conical spring, functioning to allow for greater stability than is realized through usage of the prior art. Thus, the configuration of the present invention can reduce the force experienced by the body very effectively, due to the complete control of the design of the spring, which does not change its resilience characteristics during its usage and application. The height of the spring varies with the location, with sides of the mouthguard comprising the shortest, and the center comprising the longest springs. Therefore, in total, the springs of the present invention can be designed to absorb and dissipate higher energy forces than any preexisting system used in any mouth guard.

### SUMMARY OF THE INVENTION

Athletic mouth guards are used in a variety of activities to protect the user's teeth, jaw, and head from impact forces and resulting injuries As stated in the prior art, athletes exposed to impact forces when not wearing mouth guards have been found to be susceptible to headaches, earaches, concussions and dizziness. Making the problem especially troublesome is the fact that such injuries are often not visible from inspection of the mouth or jaw.

Therefore, mouth guards are worn in a variety of sports, such as boxing, football, hockey, and a host of other activities. Most mouth guards are currently formed of thermoplastic materials and are manufactured in a variety of shapes, sizes, and thicknesses to accomplish the foregoing.

However, the mouth guards of the prior art are often ineffective Such is due to the mouth guards either failing to provide the necessary degree of absorption and dissipation of impact forces, or the mouth guards' inability to maintain their structure and effectiveness through continued usage. Therefore, a need exists for a mouth guard that provides enhanced absorption and dissipation of impact forces, that maintains ins strength and integrity for extended periods of time.

To address the problems of the prior art, the present invention is an energy absorbing system for mouth guards, utilizing a series of encapsulated springs that are always in a state of suspension Importantly, in the preferred mode, the encapsulated springs are conical in nature, and alternate between standard and upside-down orientation, providing the utmost in strength and support while preventing the springs from bottoming out upon impact. Such is a result of the unique stiffening of the conical spring during compression thereof.

An encapsulating material placed at least around the conical springs prevents the springs from being continually placed in a stressed situation, thus maintaining their structural integrity. Such encapsulating material may be made of a polymeric or thermoplastic material, which conforms to the conical shape of the springs and their respective apertures, functioning to aid in the dissipation of impact forces. In enhanced modes, the polymeric or thermoplastic material may also be placed within the interior of a conical spring, to provide additional stability and absorption and dissipation of forces.

The uniqueness of the encapsulation of the springs is that such a configuration allows for specific designs, lengths, and widths, as well as ease of placement in pre-formed openings in the padding or encapsulating material for the manufacture of the final product

Because the springs work in conjunction with one another, and because the springs work in conjunction with the encapsulating material, the present invention provides a durable, long-lasting system that allows for previously-unattained stability.

It is important to note that the height of the conical springs may vary, such as a variance from corners of the mouth guard to the center thereof. This provides increased absorption of forces in a widespread area, much to the benefit of the user.

Based on its unique configuration, the mechanism of the present invention can reduce the force experienced by the body to a level better than 50%. Such is due to the complete control of the design of the spring, which does not change its spring or resilience characteristics during its usage and application Therefore, in total, the springs of the present invention can be designed to absorb and dissipate higher energy forces than any preexisting system used.

Depending upon the exact environment in which the same are to be used, the conical springs may be constructed of polymers or metals including titanium and steel—lightweight, yet durable materials to accomplish the purposes of the invention.

In any such embodiment, the stiffness of the springs of the invention may be tailored to an appropriate degree according to the type of activity in which the invention is utilized. As previously noted, such stiffness is inherently enhanced by the conical shape of the springs utilized in the preferred mode.

Thus, in total, the present invention lessens the incidence and severity of injury in a great variety of sporting activities, at low costs and with ease of manufacture and installation.

Therefore, it is the object of the present invention to provide a unique spring assembly for usage in mouth guards, for the purpose of enhancing absorption and dissipation of impact forces.

It is specifically the object of the present invention to provide a mouth guard assembly utilizing a plurality of springs encapsulated within padding material, such that impact forces are spread out and distributed widely for the benefit of the user.

It is a further object of the invention to provide a mouth guard assembly that is effective for a host of sporting activities and additional applications where mouth and jaw protection is desired

It is also an object of the present invention to provide a mouth guard assembly that requires less padding material to be used, thus reducing the weight of the item in question and increasing the comfort of the user.

It is generally an object of the present invention to provide a mouth guard assembly that is relatively inexpensive to manufacture.

It is also an object of the present invention to provide a mouth guard assembly that utilizes springs in both right-side up and upside-down orientation, to provide the highest level of absorption and dissipation available.

It is further an object of the present invention to provide a mouth guard assembly utilizing conical springs that provide strength and durability for longer periods than the springs utilized by the prior art.

The novel features which are considered characteristic for the invention are set forth in the appended claims The invention itself, however, both as to its construction and its method of operation, together with additional objects and advantages thereof, will be best understood from the following description of the embodiments when read and understood in connection with accompanying drawings.

### BRIEF DESCRIPTION OF PREFERRED EMBODIMENTS

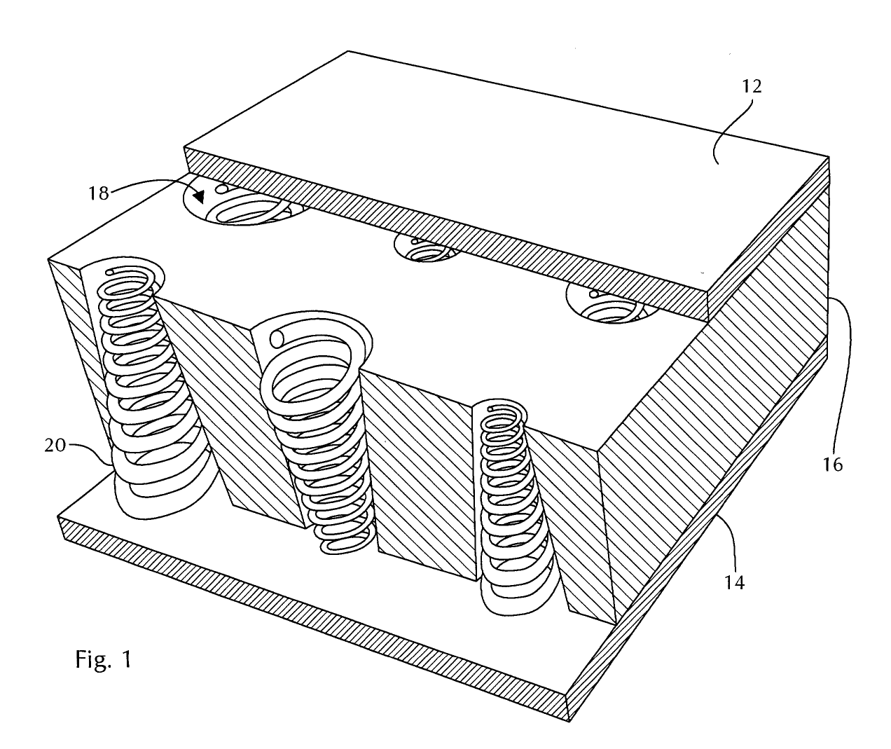

FIG. 1 is a top cut-away view of the mouth guard, illustrating conical springs encapsulated within conical apertures in padding material therefor

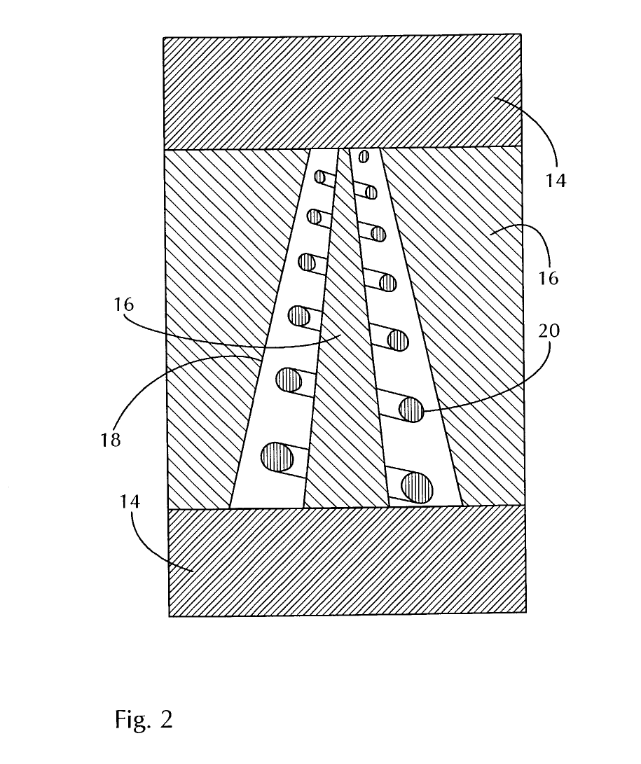

FIG. 2 is a side cut-away view of the mouth guard, illustrating a conical spring encapsulated within a conical aperture therefor, and entirely surrounded by polymeric material, including polymeric material within the interior of the conical spring.

### DETAILED DESCRIPTION OF THE PREFERRED EMBODIMENT

This description relates to the general comments herein, as well as the figures referred to above. FIG. 1 is a top cut-away view of the present invention. Included are the primary components of the assembly: upper layer (12), lower layer (14), padding (16), conical apertures within the padding (18), conical springs (20) within the conical apertures.

Specifically, a plurality of conical springs (20) are encapsulated within corresponding conical apertures (18) within the padding (16) to provide enhanced impact and energy absorption. As depicted, the apertures are pre-formed within the padding or polymeric material, and each bear a unique conical shape in order to effectively receive and contain the conical springs in a secure manner.

Regarding FIG. 2, which is a side cut-away view of the device, illustrated is a single conical spring (20) encapsulated within a conical aperture therefore, and entirely surrounded by polymeric material, including polymeric material within the interior of the conical spring. This embodiment is especially important, as the usage of polymeric material literally within the interior of the spring adds significant stability to the system, and even enables a single large conical spring to be utilized.

In the preferred mode, the springs alternate between upright and upside-down in orientation, in an effort to make the most efficient use possible of all available space. In addition, the springs may be of varying distances from one another, according to the level of absorption and dissipation utilized. For the purposes of example, springs in close proximity will provide increased levels of absorption and dissipation, while springs further form one another will result in decreased levels of absorption and dissipation.

The number of springs utilized creates a system for great distribution and spreading of forces, thereby reducing the adverse effects of impact in a manner previously unattained. The particular quantity and location of the conical springs in FIG. 1 are shown for example purposes only.

Importantly, the presence of padding surrounding the conical springs and working in conjunction with them prevents the springs from bottoming out, or reaching their full capacity of energy absorption. Furthermore, the assembly provides for complete memory, which is instantaneous upon release of the force exerted. In addition, the configuration functions to allow the outer portion of the assembly to receive primary forces, with the conical springs receiving secondary forces, the padding receiving additional forces, and only remaining dissipated forces distributed to the user As such, the assembly compresses in a unique manner to absorb the impact of objects coming in contact therewith.

Specifically, the configuration allows for the entire series of conical springs of varying sizes to work in unison. This simply allows for a far greater amount of energy absorbed by the assembly of the present invention. Thus, regarding the present invention embodied within mouth guards, the floating system will mitigate the incidence headaches, concussions, and a host of other injuries.

In regards to both figures, the spring assembly comprises a previously-determined quantity of springs, such quantity selected according to the needs of any of a host of particular applications. For example, differing numbers of springs may be utilized according to particular needs and styles of mouth guards.

In preferred modes of manufacture, conical spring members are produced in a thickness of a range of one-sixteenth inch to three-quarter inch. However, other thicknesses of springs may be utilized if desirable.

In all such cases, the springs are manufactured in a variety of previously-determined sizes, functioning to render the springs effective for multiple previously-determined sporting events and hazardous activities.

Regarding the precise construction of the present invention, the springs may manufactured of polymeric materials, such as a durable plastic to provide strength for the assembly at inexpensive cost of manufacture

Alternatively, the springs may be manufactured of metal materials, such as steel, if desired by the manufacturer Importantly, the spring could even be manufactured of titanium, providing durability at sharply reduced weight and costs.

It is intended that the spring width also be variable according to particular needs, such as of a width of a range of one-sixteenth inch to one half inch. In all instances, the conical apertures will vary in size in accordance to the respective spring size, constantly allowing for a secure fit for each conical spring.

Moreover, the spring assembly may be manufactured in a variety of previously-determined sizes, functioning to render the spring assembly effective for multiple previously determined sporting events and hazardous activities. In any such instance, the presence of the springs within the padding or wall will significantly reduce the quantity of padding material needed, thus reducing weight and manufacturing costs

With regards to all descriptions and graphics, while the present invention has been illustrated and described as embodied, it is not intended to be limited to the details shown herein, since it will be understood that various omissions, modifications, substitutions and changes in the forms and details of the device illustrated, and in its operation, can be made by those skilled in the art without departing in any way from the spirit of the invention.

Without further analysis, the foregoing will so reveal the gist of the present invention that others can readily adapt it for various applications without omitting features that from the standpoint of prior art, constitute characteristics of the generic or specific aspects of this invention what is claimed as new and desired to be protected by letters patent is set forth in the appended claims.

What is claimed is:

1. An impact and energy absorbing mouth guard utilizing multiple conical springs, comprising:
padding comprising an outermost layer and innermost layer, and further comprising a plurality of conical apertures, each of a previously-determined size, and each located in a previously-determined area;
a plurality of conical spring members, each of a previously-determined varying length, inserted within the conical apertures of the padding, and encapsulated by the padding;
a previously-determined quantity of the conical spring members upright in orientation, and a previously-determined quantity of the conical spring members upside-down in orientation;
the outermost panel covering the plurality of springs of the assembly, the outermost panel functioning to receive primary forces coming in contact therewith, with the plurality of springs receiving secondary forces, the padding encapsulating same receiving additional forces, and only remaining dissipated forces distributed to a user.

2. The impact and energy absorbing mouth guard as described in claim 1, wherein longer springs are located at a center portion of the mouth guard, and gradually shorter springs are located towards corners thereof.

3. The impact and energy absorbing mouth guard as described in claim 1, wherein springs are located along the length of the entire mouth guard.

4. The impact and energy absorbing mouth guard as described in claim 1, wherein the mouth guard is used for an activity selected from the group consisting of boxing, wrestling, football, arena football, ice hockey, roller hockey, roller skating, skateboarding, field hockey, lacrosse, auto racing, and motorcycle racing.

5. The impact and energy absorbing mouth guard as described in claim 1, wherein the presence of springs within the assembly reduces a quantity of materials needed, thus reducing weight and manufacturing costs.

6. The impact and energy absorbing mouth guard as described in claim 1, wherein each spring is tailored to absorb and dissipate foreseeable forces of ground surfaces, objects coming in contact with the spring assembly.

7. The impact and energy absorbing mouth guard as described in claim 1, wherein the springs are manufactured of polymeric materials.

8. The impact and energy absorbing assembly mouth guard as described in claim 1, wherein the springs are manufactured of metal materials, including steel and titanium.

9. The impact and energy absorbing mouth guard as described in claim 1, wherein the spring is of a width of a range of one-sixteenth inch to one half inch.

10. The impact and energy absorbing mouth guard as described in claim 1, wherein the spring assembly is manufactured in a variety of previously determined sizes, functioning to render the spring assembly effective for multiple previously-determined sporting events and hazardous activities.

11. The impact and energy absorbing mouth guard as described in claim 1, wherein conical spring members upright in orientation, and conical spring members upside-down in orientation are utilized in alternating format.

12. The impact and energy absorbing mouth guard as described in claim 1, wherein padding is located within an interior of at least one conical spring, functioning to allow for increased absorption and dissipation of impact forces.

13. The impact and energy absorbing mouth guard as described in claim 1, wherein the springs are coated with a polymeric material, functioning to reduce friction of the spring against the encapsulating polymeric material.

14. The impact and energy absorbing mouth guard as described in claim 1, wherein the springs are located within a thin, pliable polymeric containment means, functioning to reduce friction of the spring against the encapsulating polymeric material.
